(19) United States
(12) Patent Application Publication
(10) Pub. No.: US 2004/0061891 A1
(43) Pub. Date: Apr. 1, 2004

(54) Enterprise production management of a print shop

(76) Inventor: Paul Philpot, Prescott, AZ (US)

Correspondence Address: Howard R. Popper & Associates, Ste. 35, 4436 E. Camelback Road, Phoenix, AZ, 85018, US

(21) Appl. No.: 10/261,519

(22) Filed: Sep. 29, 2002

(51) Int. Cl. B41F 1/00; G06F 15/00

(52) U.S. Cl. 358/1.15; 399/82

(57) ABSTRACT

A system for managing a multistage production enterprise, that includes one or more print-for-pay or franchised print centers, provides an interface display designed to accommodate managers who may be unfamiliar with the use of computers. The top half of the display contains “radio” buttons accompanied by icons that identify principal work areas subject to control, while the bottom half provides a status summary of the principal operations including the completion status of work, whether or not the work is proceeding on schedule and projected future work load. The selection of an icon brings up a further display, again divided in two, the upper half containing an array of addressable icons that address more detailed aspects of the selected operation and the bottom half providing more detailed status information and control. To keep the user aware of which operations are being addressed, each ensuing display repeats the originally selected icon in its upper right-hand corner as a trail-marker.

### FIELD OF THE INVENTION

This invention relates to process control systems and, more particularly, to systems useful in print-for-pay and corporate enterprise print centers.

### BACKGROUND OF THE INVENTION

Heretofore some of the problems involved in operating a high volume, high speed print shop have been discussed in Hansen U.S. Pat. No. 6,407,820, issued Jun. 18, 2002 assigned to Heidelberg, LLC. The '820 patent discloses a computer-controlled system which reads a job card that contains instructions for producing the finished product, including basic and advanced formatting and for loading the correct media into a digital or black and white production printer. Another approach to the control of printing operations is disclosed in Marconi Data Systems U.S. Pat. No. 6,384,933 issued May 7, 2002 which relies on using object-oriented modules to facilitate communication among the print job objects over a virtual control network.

Such prior art systems failed, however, to consider a number of other factors that are of importance to the profitable and efficient management of a printing enterprise. The profitability of a printing enterprise, especially the type of franchised “quick copy” print shop that usually cannot afford to employ sophisticated management personnel, must take into account the scheduling of work in relation to the utilization of resources, such as the changing availability of employees and inventory, machine maintenance and the priority to be given various orders. It would therefore be of great importance to improving the profitability of running a print shop enterprise to provide for control of the principal tasks of a print shop with a variety of interactive visual displays.

### SUMMARY OF THE INVENTION

In accordance with the principles of the present invention, a multistage process, such as a print shop, where work items are moved through a sequence of work areas such as analog and digital printers, design stations, etc., is controlled from a master console that features a divided display whose upper portion employs workbench “radio” buttons accompanied by distinctive icons to depict the principal operations that are performed so that, advantageously, a relatively unsophisticated manager may gain an immediate grasp of the overall operation. The lower portion of the master display provides a status summary of current and projected work, as well as system alerts requiring operator intervention. Addressing a workbench icon in the upper part of the display brings up a further divided display that provides more detailed management information pertinent to the addressed sub-part. “Bulldozer” icons move across the screen at a rate proportional to the speed of the actual work being performed. If the normal inventory/delivery cycle does not match the forecasted schedule, the problem is displayed so as to get the attention of the operator and to provide “roadmaps” for its solution based on the shop profile entered into the system at setup. An outsourcing process can be initiated for work scheduled to be processed by any equipment that is down. To keep the user aware of which operations are being addressed, each ensuing display repeats the originally selected icon in its upper right-hand corner as a trail-marker. Upon job completion, the job is archived in a job library and is available for recall if the customer desires to rerun the same job.

### BRIEF DESCRIPTION OF THE DRAWING

The foregoing and other objects and features of the present invention may become more apparent from a reading of the ensuing specification, together with the drawing in which:

FIG. 1 is a view of the master console MC containing the divided workbench display according to the invention;

FIG. 2 shows the system administration workbench TA that may be accessed through the master console of FIG. 1;

FIGS. 3 through 7 shows views of the production control workbench PC that may be accessed through the master console of FIG. 1;

FIG. 8 shows the operations management workbench OP that may be accessed through the master console of FIG. 1;

FIG. 9 shows the business desk BD that may be accessed through the master console of FIG. 1; and

FIG. 10 provides an overall flow chart of the processes controlled by the workbenches identified in master console MC of FIG. 1.

### DETAILED DESCRIPTION

The operation of a print shop can be described by five principal tasks: the receipt of new orders, in-put processing of orders, pre-press work, production processing and post-processing. Customers may initiate work for a print shop by physically arriving at the shop with an order, submitting an order by e-mail, fax, telephone, job estimating system, or from the job library. In any case, an incoming order is entered into a computer-driven job ticket at PP-0 which will guide further processing through the principal stages of a print shop operation. In accordance with an aspect of the present invention, however, before accepting any new work it is important to enter into the computer through the master console, a description or “profile” of the print shop's resources that will define the print shop as an operational facility (e.g., the number and characteristics of digital and non-digital printers and other work stations, inventory of materials kept on hand for use in the print shop's operation, types and number of personnel, personnel policies, calendar items, etc.)

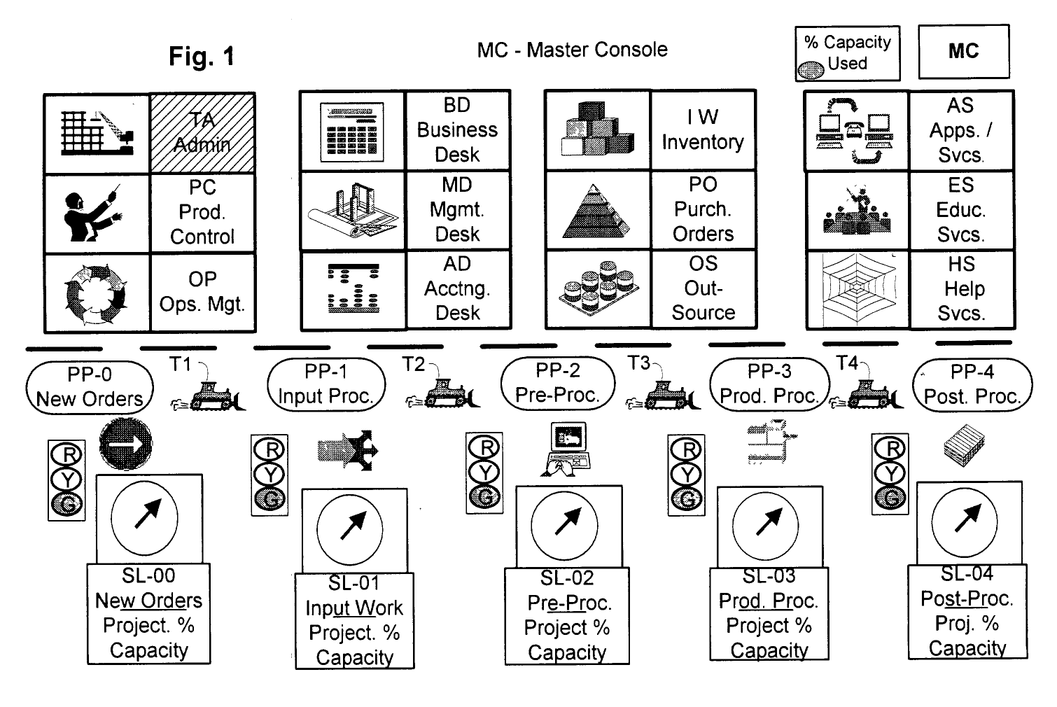

Once the print shop profile has been loaded into the system, new work may be received. Each job will likely require different processing operations which will be defined by the job ticket. The assortment of jobs that can simultaneously be handled, each requiring different amounts of time at each process stage, imposes a varying workload on the available resources. Accordingly, there will usually exist a build-up of jobs-in-process and jobs waiting to be processed. The present invention provides the manager with a console display to answer the questions “what is the state of operations?” and “how can I control it better?”. The answers to the first of these questions is made available in the upper portion of the master console display, FIG. 1, while the answer to the second question is made available in the lower portion.

In accordance with fulfilling an aspect of the present invention to make print shop management accessible to those who may be familiar with print shop operation but who may not be completely comfortable with computers, the “drop-down” menus that are familiar to most computer users are avoided in the initial display offered by the master console. Instead, “workbench” icons, accompanied by text, delineate print shop operations that relate to familiar print shop operations are displayed in an upper portion of the master console. These workbenches are listed in the left-hand column of Table 1 below.

The lower portion of the master console provides a display board subdivided into rows, a row of icons and associated traffic lights to indicate by “red” R, “green” G or “yellow” Y the status of the principal print shop: New Orders at PP-0, Input Processing of Jobs at PP-1, Pre-Processing of jobs at PP-2, Production Processing of jobs at PP-3 and Post-Processing of jobs at PP4. A respective “bulldozer” or “tractor” icon T1, T2, T3, T4, pointing to the right, moves between each of the above processes to illustrate the normal direction of workflow. The rate at which the bulldozer moves is advantageously set to be somewhat more than proportional to throughput since a purely proportional movement for the three traffic light conditions would not be as noticeable. Accordingly the tractor movement is set so that, if there are no problems, i.e., the traffic light is green G, the tractor moves to the right five pixels every 20 milliseconds. If there is a warning indicator, e.g., the traffic light is yellow Y, the tractor moves 1.5 pixels every 20 ms. If there is a serious problem, e.g., the traffic light is red R, then the tractor does not move.

Below the traffic light row there is an array of gauges that summarize the present percentage of system capacity occupied with handling these processes and the future projected percentage of system capacity scheduled to be involved. For simplicity, only a few of the gauges in this row have been shown, namely, New Orders at SL-00, input processing workload at SL-01, pre-processing workload at SL-02, production processing workload at SL-03 and post-processing workload at SL-04.

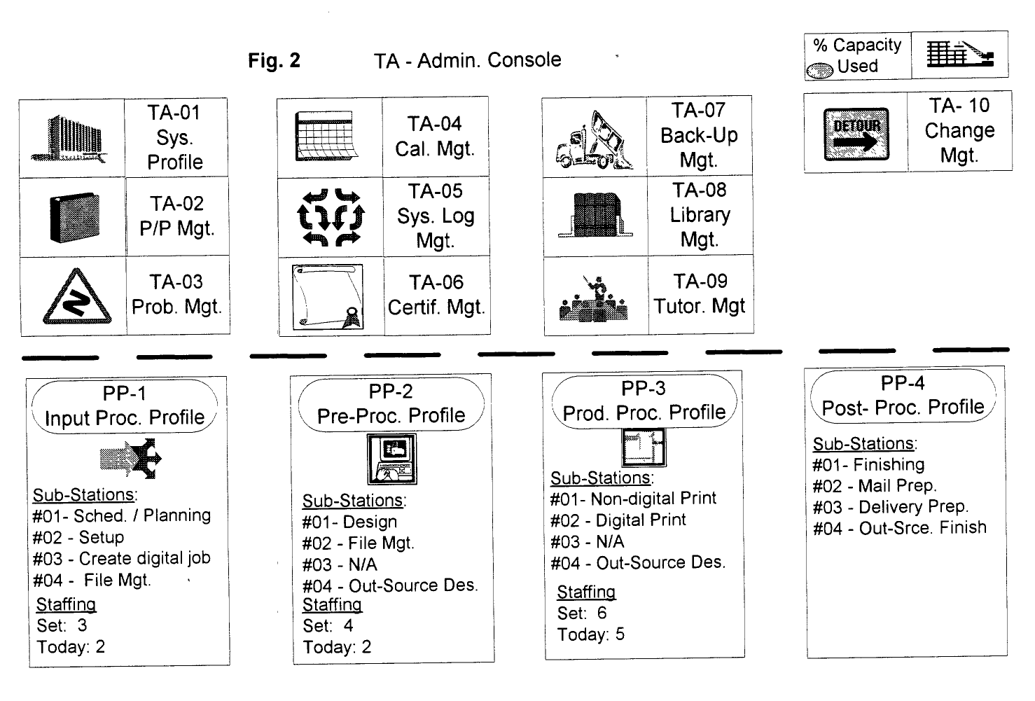

When the print shop manager selects a workbench icon in the upper portion of the FIG. 1 master console MC, a new display, having its own distinctive upper and lower portions, is brought up. To guide the manager in what he is looking at, the upper right-hand portion of each such subsequent display that relates to the selected workbench repeats the icon that was selected on the master console. For example, in FIG. 1, the TA-Admin workbench has been highlighted to indicate that it has been selected while FIG. 2 shows the subsequent TA-Admin workbench display. Notice that the TA-Admin workbench repeats the TA-admin icon in its upper right-hand corner. In addition, each of the subsidiary workbench icons in the upper portion of the TA-Admin workbench is designated “TA-”. FIG. 2 shows an array of ten subsidiary workbenches TA-01 through TA-10 while the lower portion shows the status of the shop's profile of resources (sub-stations) devoted to each of the operations PP-1 through PP-4.

FIG. 1 may now be reviewed together with Table 1 in which the left-hand column lists the workbenches and the right-hand column lists the status displays corresponding to each workbench. Table 2 lists the detailed functions controllable through the workbenches when selected at the master console:

TABLE 1

| Upper Portion: | Lower Portion: |
|---|---|
| Workbenches | Display Board & Command |
| Master Console | Overall Shop Tools Access & Status |
| 1. TA Admin | Shop Profile Configuration Management |
| 2. PC Production Control | Production Status Management |
| 3. OP Operations | Production Workflow Management |
| | animated “Bulldozer” |
| 4. BD Business Desk | Front Desk Production |
| | Orders Management |
| 5. MD Management Desk | Manager or Supervisor Shop |
| | Status Overvue |
| 6. AD Accounting Desk | Shop Accounting Processing & Status |
| 7. IW Inventory Workbench | Inventory Management and Status |
| 8. PO Purchase Order Mgmt | PO Management and Status |
| 9. OS Out Source Mgmt | Out-Source Jobs Management and Status |
| 10. AS Apps & Services | Apps & Services Access |
| 11. ES Education Services | Education Services Access |
| 12. HS Help Services | Help Services Access |

TABLE 2
WORKBENCH FUNCTIONS

| Production | Business | Materials | Support Services |
|---|---|---|---|
| TA Admin | BD Business Desk | IW Inventory Mgt. | AS Support Svcs. |
| TA-01. Sys. Profile | BD-01 Job Estimate | IW-01. Inventory Status | AS-01 Network Mgt. |
| TA-02 Policy/Proc. Mgt | BD-02 T-Job Definition | IW-02 Withdraw Inv. | AS-02 Comm. Mgt. |
| TA-03 Prob. Mgt. | BD-03 Payment type | IW-03 Receive Inv. | AS-03 Oper. Mgt. |
| TA-04 Cal. Mgt. | BD-04 Cust. paperwk | IW-04 Adjust Inv. | AS-04 Digital Prtr. |
| TA-05 Sys. Log. Mgt. | BD-05 Items not chgd | IW-06 Set Inv. Levels | AS-05 Web Input |
| TA-07 Backup Mgt. | BD-06 Target ROI | | |
| TA-08 Library Mgt. | BD-07 Shop status | | |
| TA-09 Tutor Mgt. | BD-08 Shop Inventory | | |
| TA-10 Change Mgt. | BD-09 Shop Changes | | |
| TA-11 Tutorial Mtce. | | | |
| PC Production Ctrl. | MD Managmnt. Desk | PO Purchase Order | ES Educ. Svcs. |
| PC-01 Q-Job Def. RM | MD-01 Job Orders | PO-01 Identify Suppliers | (Tutorials) |
| PC-02 Scheduling RM | MD-02 Prod. Ctrl. | PO-02 Create New PO | |
| PC-03 Sched Bd. Disp | MD-03 Sched. Bd. | PO-03 Aged PO Status | |
| PC-05 Capacity Disp. | MD-04 Calendar | PO-04 Check Inventory | |
| PC-06 Status Alerts | MD-05 Inventory | PO-05 Print PO | |
| PC-07 Syst Status | MD-06 Purch. Orders | PO-06 Close POs | |
| PC-08 Syst Backup | | | |
| PC-09 Resources | | | |
| PC-10 0 Qut Source | | | |
| OP Operations Mgt. | AD Account'g Desk | OS Out-Source Mgt. | HS Help Services |
| OP-1. Incoming Jobs | AD-1. Pay. Conversn. | OS-1. Identify Suppliers | HS-1. Access Web |
| OP-2. Job Setup | AD-2. Worksheet | OS-2. Create New PO | HS-2. Log Sys. Probs |
| OP-3. Doc. Design | AD-3. Business Repts | OS-3. Open PO Stat. | HS-3. Validate Sys. |

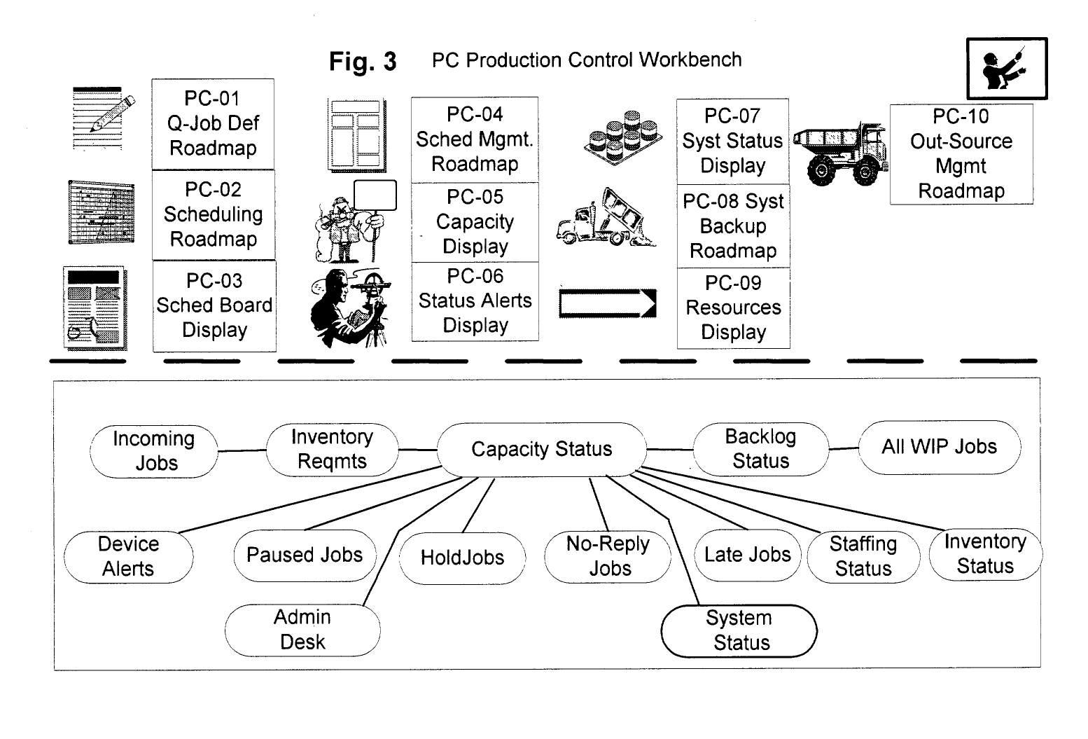

FIGS. 3 through 7 show various views of the Production Control workbench PC which is brought up when the PC Prod. Control radio button of FIG. 1 is selected. Notice that in the upper right-hand corner of these figures the same icon is displayed that is shown in FIG. 1 and which indicates to the inexperienced user that the display concerns aspects of production control. The various segments of the production control workbench provide a “roadmap” that explains to the print shop manager how to perform each operation that is required to manage the print shop workload. FIG. 3 shows the state of the display before any radio button is selected. The upper part of the display contains the following radio buttons: PC-01 Q-Job Def Roadmap which provides commands to enable quick definition of jobs; PC-02 which provides a form for defining a new job schedule; PC-03 which displays a schedule board; CP-04 which provides commands to manage the workload; PC-05 which displays the current system capacity available to handle each print shop operation; PC-06 which displays all operational status alerts; PC-07 which displays system component status; PC-08 which displays the system backup roadmap; PC-09 the resources display; and PC-10 the out-source management roadmap.

Referring to FIG. 3, the lower portion the display shows the Signal Bubbles Grid whose components change color from green to yellow to red to show in summary fashion the status of: Incoming jobs, Late jobs, Paused jobs, Jobs on hold, Jobs for which No Reply has been received, Inventory requirements of jobs, System capacity, overall status of all Work in Progress (WIP), System capacity, Staffing, Backlog and the state of the Admin desk. The Signal Bubbles Grid forms a network of signals that reflect the changing status of the various components within a given area of responsibility. The “Bubbles” change color as the status changes, e.g., Green=go or on schedule, Yellow=caution, there is a slippage in the schedule, Red=stop, a problem has occurred that is impacting the production processing.

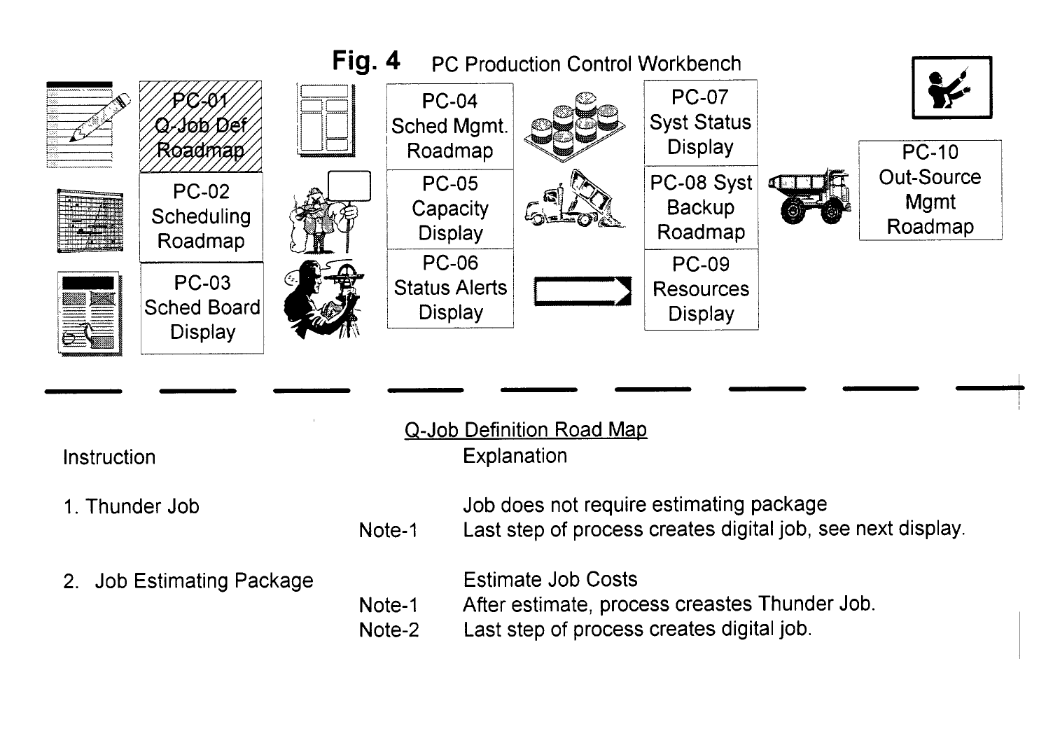

When PC-01 is selected, as shown in the shaded upper portion of FIG. 4 of the production control workbench, a “quick-job definition” roadmap enables the manager to quickly access the commands to define a job. The lower portion of FIG. 4 illustrates the condition where a “Thunder” job is explained as being a job which does not require a third-party estimating package to be employed and which makes available an internal job estimating package to be accessed.

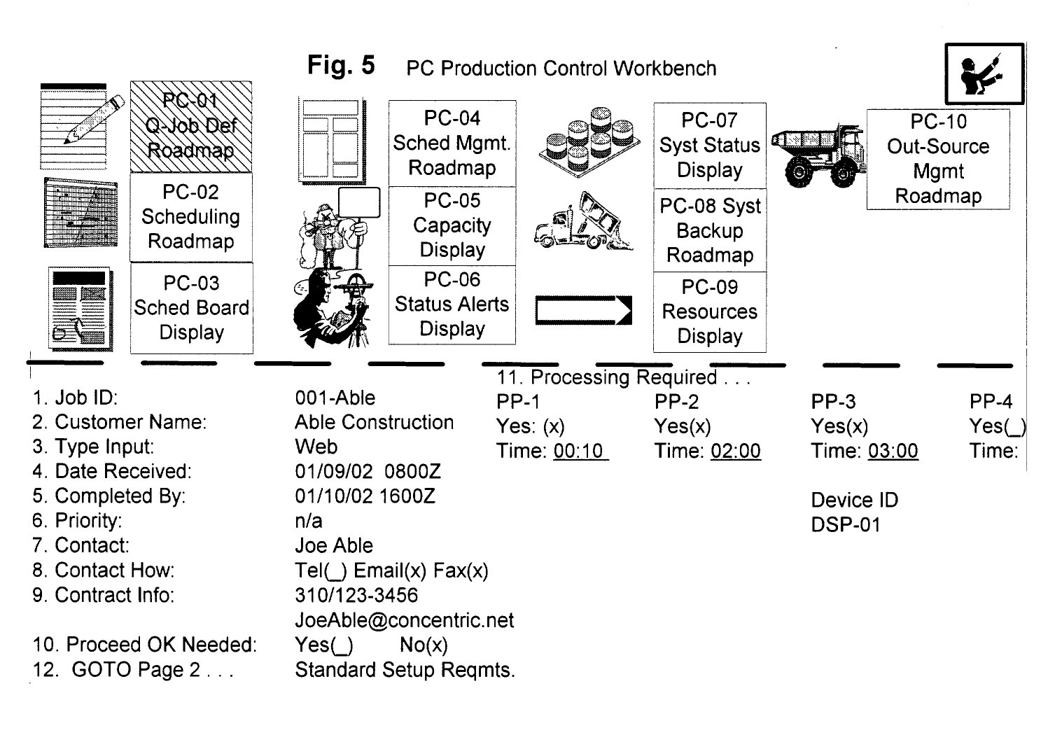

FIG. 5 shows the “second page” of the PC-01 Q-Job definition roadmap. In FIG. 5 the lower portion of the display continues with additional details of the job definition roadmap showing 12 illustrative fields for inserting relevant Input Instructions. Item 1 allows the Job ID to be entered and is illustrated as “001-Able”. Item 2 is for the customer's name. Item 3 is to identify how the job was input to the system and is illustrated as “web input”. Item 4 is the date received; item 5 is the date by which the job is to be completed; Item 6 is the priority to be accorded the job; Item 7 is the name of the customer contact; Item 8 is the manner in which the contact is to be made whether by fax, e-mail or by telephone; Item 9 is the contract number for the job; Item 10 indicates whether further approval is required; Item 11 identifies whether each of the types of processing PP-1 through PP-4 are required and the time for each.

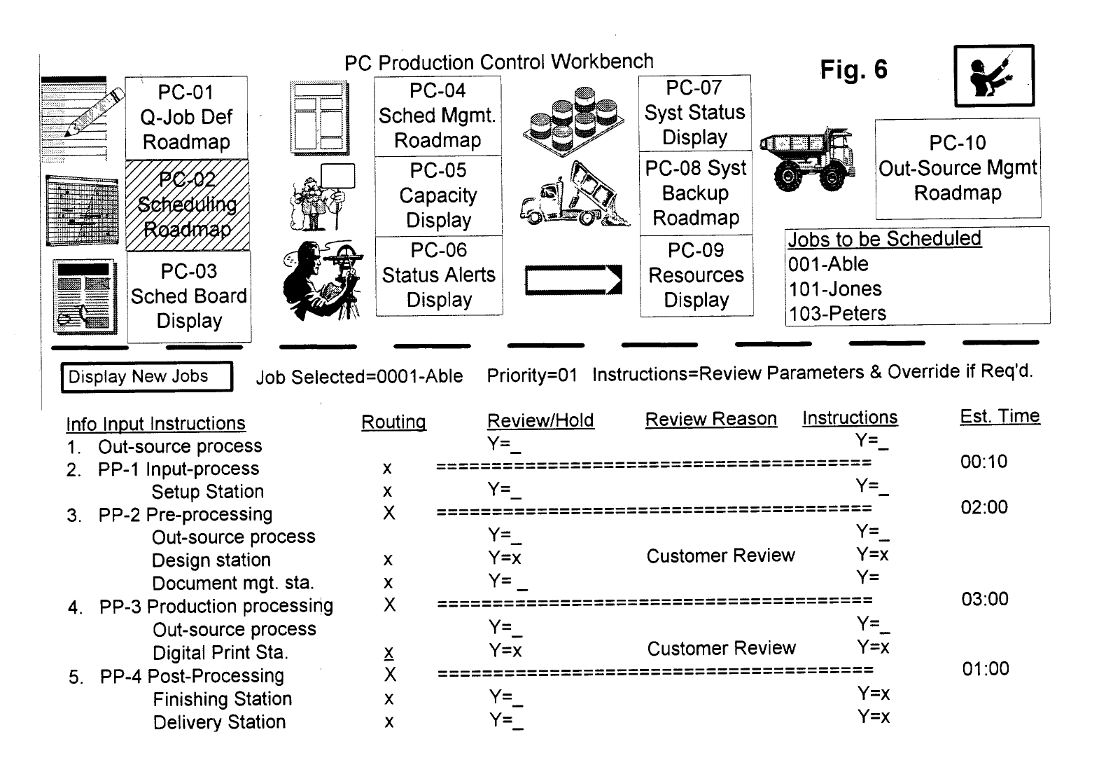

FIG. 6 shows the view of the production control workbench when the scheduling functions roadmap radio button PC-02 is selected. PC-02 provides a form for defining detailed information about a job, including: (a) out-source routing; (b) document management tasks; (c) review holds; reason for reviews; (d) special instructions; and (e) revised time estimates. If the Job Definition that is received contains all the necessary information, this function can be by-passed.

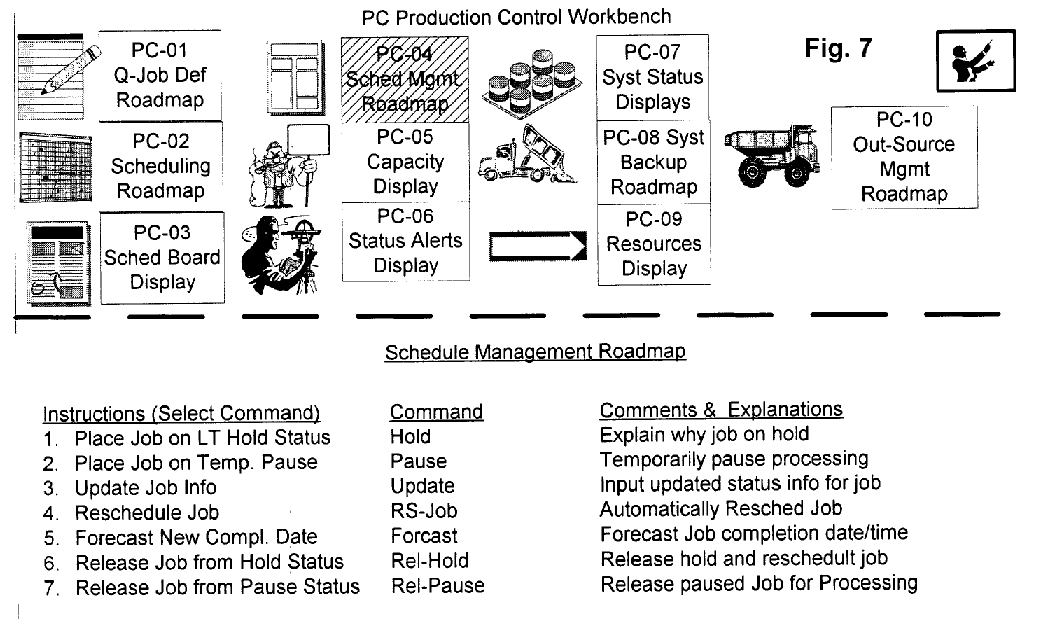

FIG. 7 shows the view of the production control workbench which contains a display that is activated when PC-04 is selected. PC-04 brings up the schedule management roadmap to enable various modifications to be made in the scheduling of workload. Among the instructions made available are commands to place a job on hold status; place a job on temporary pause status; insert updated information concerning a job; re-schedule a job; forecast a new completion date; release a job from hold status and release a job from pause status.

FIGS. 3 through 7 also show a number of other radio buttons of the production control workbench whose functions such as PC-03, Sched Board Display, which displays the scheduling of all jobs in the system, are largely self-explanatory. PC-05 is the capacity display which show the current capacity status of each operation. PC-06 displays all of the operational status alerts. PC-07 displays the status of all system components. PC-08 shows the system backup roadmap; PC-09 shows the Resources display; and PC-10 shows the out-source management roadmap which explains how to assign job to off-premises firms that have previously enrolled in the system as willing to have their idle resources put to use.

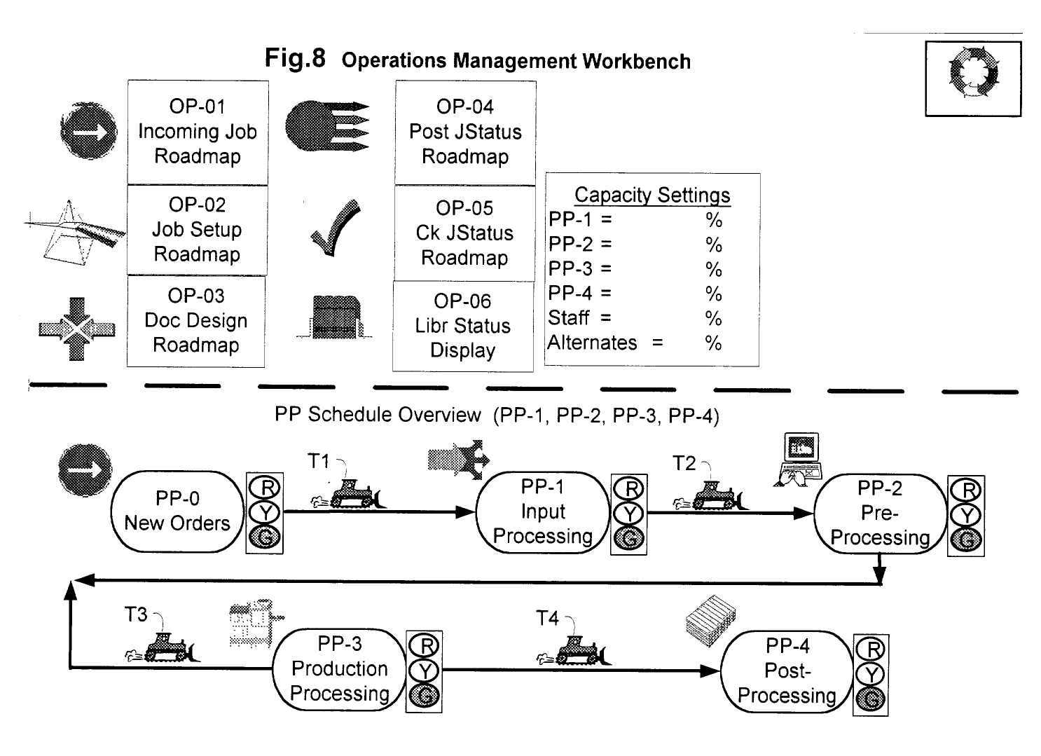

FIG. 8 shows the Operations Management Workbench OP. Notice that in the upper right-hand corner of this workbench the same icon is shown as appeared in the master console view FIG. 1 to identify that the user has selected the operations management workbench. The upper portion of the operations. management workbench provides six radio buttons, OP-01 Incoming Job roadmap; OP-02 Job Setup Roadmap; OP-03 Document Design Roadmap; OP-04 the Post Job Status Roadmap; OP-05 the Check Job Status Roadmap; and OP-06 the Library Status roadmap. In addition, the Capacity settings for the four processes PP-1 through PP-4 are shown together with the percent Staff available and the percent alternate staff available. In the lower portion of the operations management workbench the “pipeline” sequence of job processes PP-1 through PP-4 is depicted with the signal lights RYG at each process and the stylized bulldozers between processes graphically depicting throughput at each step in somewhat similar fashion to that described above in connection with the master console of FIG. 1 so that the manager can gain an overall impression of rate at which these processes are functioning to execute a job.

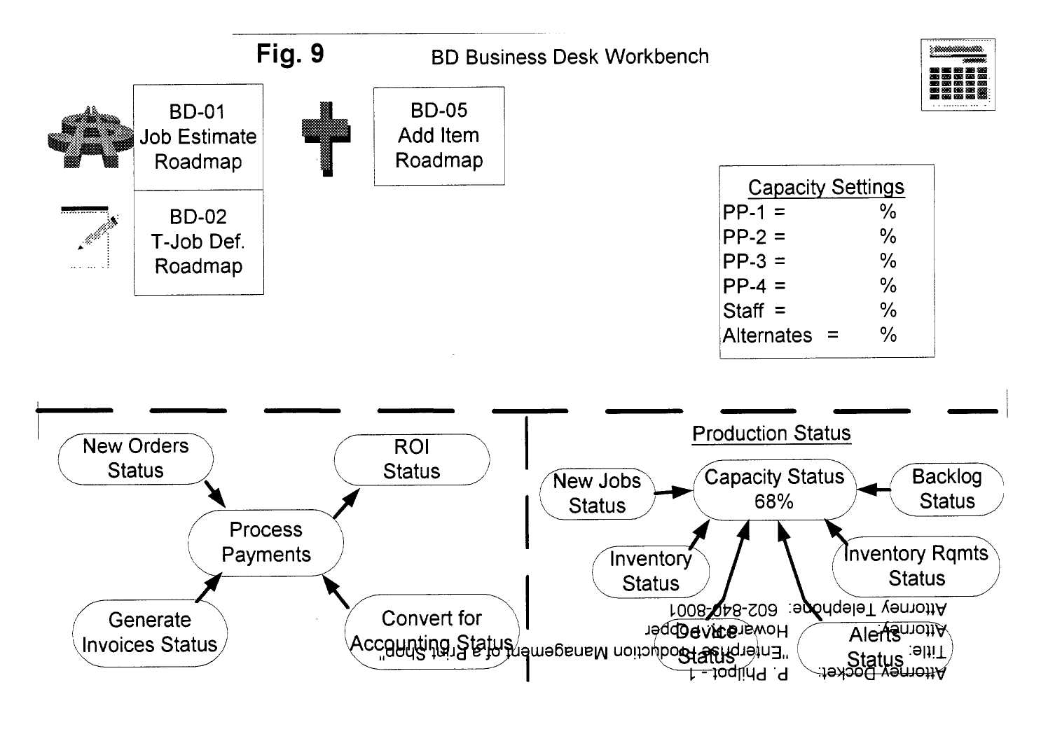

FIG. 9 is the Business Desk Workbench. Notice that in the upper right-hand corner of this workbench the same icon is shown as appeared in the master console view FIG. 1 to identify that the user has selected the business desk workbench. Because some of the “business” functions overlap some of the other functions being executed in a practical print shop, a certain amount of redundancy is deliberately provided in the displays. See for example, the repetition of the “Capacity Settings” display which also appeared in the Operations Management Workbench. Other important aspects of the status of system operation are displayed in the lower portion of the Business Desk Workbench, notably the Status of New Orders, the status of return on investment ROI; the processing of payments; the status of invoice generation; the status of new Jobs; the status of inventory; and backlog status.

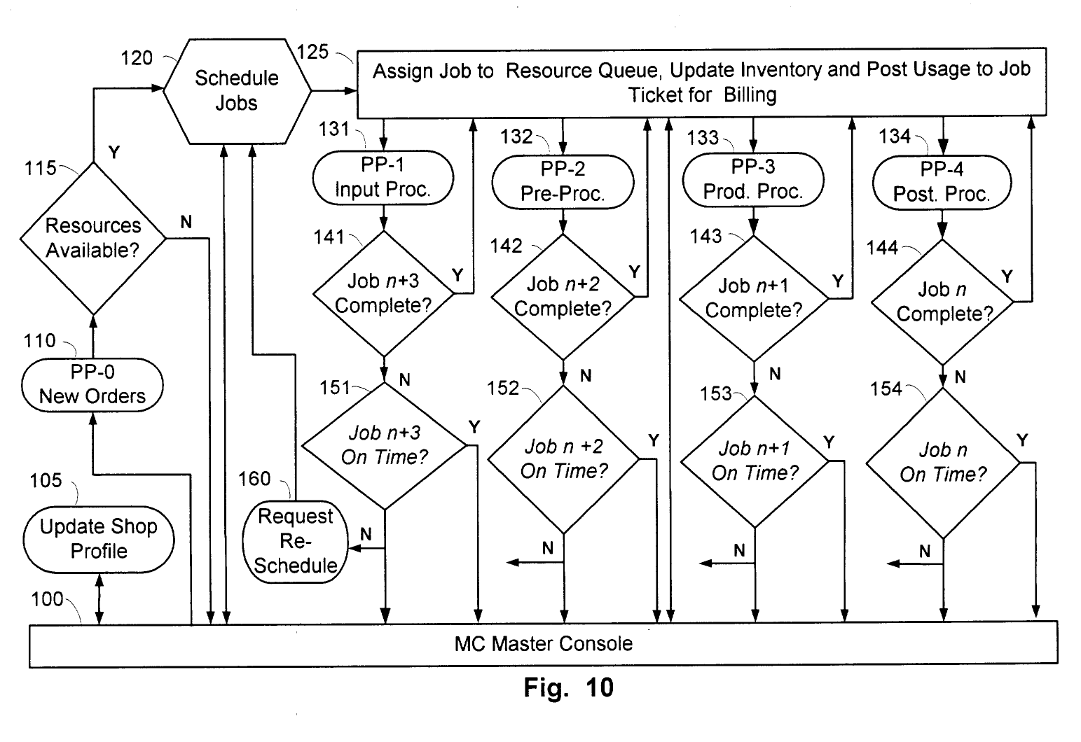

FIG. 10 is a flow chart of the print shop operations controllable via the master console MC 100. The first task presented to the manager when opening a print shop for the first time is to enter into the system computer all information necessary to up-date a pro-forma print shop profile. The detailed attributes of the print shop's resources are entered at step 105. The profile then contains the parameters of all of the many types of resources, including personnel, used in a typical print shop and it is desirable that they be identified in as detailed a fashion as possible. Accordingly, the profile will include: the number and capabilities of print shop personnel including payroll account numbers as well as an alpha-numeric descriptor identifying the skill category and experience level ranging from machine operators and helpers to designers and shift managers and regional managers; the number and types of off-set presses; analog and digital printers; the inventory of materials and supplies including, cutters, drills, glue-binders, staple-binders, spiral-binders, folders, etc. In addition, information concerning vendors and sources of supply as well as budgetary, financial and payroll information should be entered. To broaden the capabilities beyond those resources physically present in the instant print shop, information about resources available at other print shops who may want to put their idle resources to use, may be entered.

In addition, at step 105, each resource is assigned a unique ID and a resource class that reflects the type of resource so that resources can be addressed individually or collectively. For example, each of the designers will be assigned a unique personal ID, but the same class assignment “designer”. The same is true for the pressmen and for presses and other items in the profile. By combining area, ID, and class, each employee and each piece of equipment is identified so that capacity management can be performed. The updated print shop profile information gathered at step 105 should therefore be as detailed and comprehensive as possible.

When new orders arrive, whether by a customer physically appearing at the print shop or by electronic means, the specifications defining the print job are entered into an electronic “job card” at step 110. At step 115 the job card is read and analyzed with the aid of information stored in the shop profile register 105 to determine what shop resources will be required by the job and whether the identified resources are available. The availability of personnel is determined by consulting a time clock (not shown) linked to the system computer into which employees log in and log out their presence. If the required resources are available, the list of resources in the shop profile is decremented and step 115 passes control to scheduling/ forecasting subsystem 120 which requests that queue control 125 enter the job in the Input Processing queue PP-1.

If the required resources are not available, scheduling sub-system 120 is consulted to determine at what future time(s) the required resource will be available. If the job can be scheduled within the time desired by the customer, the job is assigned to the relevant queue. If the job cannot be so scheduled, system at step 115 activates the relevant display at master console 100. When so notified, the manager can call up out-source workbench OS (FIG. 1) to consider whether the job should be farmed-out.

When step 115 determines that the requisite resources are or will be available at the required time and control is passed to the assignment module 125, the job is, as mentioned, entered into input processing queue 131. When the input processing of the job is complete step 141 notifies assignment module 125 to enter the job into the next queue, pre-processing queue 132. In this manner, as determined by the job card, a job is passed from one to another of the sequence of work area queues 131 to 134 until the job is completed.

During each phase of processing, checks are continuously made at steps 151 through 154 to determine whether a job is on schedule. If a job is not on schedule, a re-schedule request 160 is made of scheduling/ forecasting subsystem 120 to provide a revised estimated completion time. Sub-system 120 updates the master console displays, alarms, signal lights, status messages, and highlights job queue information, based upon forecasted completion dates-times for the jobs. From the look-ahead indication provided, the manager can inform the customer of an alternative delivery time or date. When production problems arise that cannot be scheduled, scheduling/ forecasting sub-system alerts the master console 100 to display the appropriate alarms. The manager so alerted may then choose to access one of the administrative services workbenches AS (FIG. 1) to gain an insight into alternative approaches based on company policy directives stored in the computer.

When a phase of operation is completed, the operator at the relevant workstation so indicates and control is passed via one of the decision steps 141 through 144 back to the assignment module 125 for the next processing phase. While an operation is progressing, the relevant one of steps 151-154 determines whether the job is on schedule. If the job is not on time, the relevant display at master console 100 is activated and a signal is passed to request the rescheduling of the job at step 160.

Among the other workbenches accessible at master console MC, FIG. 1, Business Desk workbench BD provides access to the tools that enable the manager to perform functions of a business nature, including order status, production status, schedule board, device status, general alerts status, staffing status, out-source status, purchase order status, library status, capacity status, backlog jobs status, all work-in-process job status. In addition, this display board provides a snapshot of finances such as status of payments and on-going ROI.

The accounting desk AD provides access to the tools that enable the accountants to perform their daily job, including conversion of the business desk payment data to generally accepted accounting formats that employ worksheets and provide reports, create banking reports, record time cards, check inventory & purchase order status, set work plan calendar, check out-source status and set a desired ROI threshold. In addition, the display board provides a work plan with indicators that track the completion or status of the work plan tasks, including . . . convert business desk payment worksheet, set weekly schedule indicators, prepare ROI report, set ROI levels, create ROI report, create payroll reports, create banking reports, and create management reports.

The inventory management workbench IW provides access to the tools that enable the assigned personnel to perform their daily job, including adding, changing, and deleting inventory items, withdraw inventory, receive inventory, adjust inventory stock, set order point inventory levels, identify inventory suppliers, organize inventory layout/storage, check backorder status, and forecast inventory requirements based upon jobs received. In addition, this display board provides a record of all inventory items.

The purchase order management workbench PO provides access to the tools that enable the assigned personnel to perform their daily job, including updating the supplier database, adding, changing, and deleting purchase orders and purchase order items, checking the status of open purchase orders, checking the age of purchase orders, checking inventory status, printing purchase orders, closing filled purchase orders, creating electronic data interchange (EDI) purchase orders, and transmitting EDI purchase orders. In addition, this display board provides a record of all purchase orders, items ordered, and the status of each purchase order.

The outsource management workbench OS provides access to the tools that enable the assigned personnel to access the database of companies that can perform work that, for one reason or another (indicated in the company policy library, TA-08 of the TA-Admin Console, FIG. 2) may be better performed at an off-premises facility. In addition, the display board provides a record of each out source purchase order.

What has been described is deemed to be illustrative of the principles of the present invention. Further and other modifications will be apparent to those skilled in the art and may be made without, however, departing from the spirit and scope of the invention.

What is claimed is:

1. In a multistage process where work items are moved through a sequence of work areas, a computer controlled system including software means for displaying on a console associated with said computer a visual presentation of the real time progress of said work items in said areas, said means including:
means for receiving and storing a profile of the resources that can be employed in each of said work areas;
means for consulting said profile to determine the availability of said resources to perform an item of work;
means for scheduling said work items for said resources determined to be available;
means controlled by said scheduling means for assigning said work items to queues for said resources; and
means for displaying the status of said queues at said console.

2. In a multistage process according to claim 1, the improvement wherein said means for determining the availability of said resources subtracts from said profile the number of resources assigned to said work areas.

3. In a multistage process according to claim 2, the improvement wherein said means for determining said availability of said resources consults said scheduling means to determine the availability of said resources at predetermined times in the future.

4. In a multistage process according to claim 2, the improvement wherein said pre-determined times are displayed to be selectable at said console.

5. In a multistage process according to claim 2, the improvement wherein means for displaying displays an alarm condition at said console when any of said resources are not available within one of said pre-determined times.

6. In a multistage process according to claim 2, the improvement wherein said means for assigning said work items to said queues is controllable at said console.

7. In a multistage process according to claim 5, the improvement wherein said means for assigning said work items to said queues is controllable to reassign said work items to a different one of said queues.

8. In a multistage process according to claim 7, the improvement wherein said means to re-assign said work items is controllable at said console to assign a work item to one of said plurality of queues for resources outside said system.

9. In a multistage process according to claim 1 wherein said visual representation includes moving a stylized icon along an axis according to the rate at which said work items are being processed.

10. In a multistage process according to claim 1 wherein said visual representation includes displaying first, second and third colors to summarize three ranges of said rates.

11. In a multistage process according to claim 1 wherein said means for displaying said visual representation includes a display of both the present and the next succeeding ones of said process stages.

12. A system for managing a multistage production enterprise where work items are moved through a sequence of work areas, a computer-controlled system comprising:
an interface having a screen displaying a plurality of workbench icons identifying principal resources for controlling said stages of work;
said screen including a status board showing in summary fashion whether each item of work is proceeding on schedule, said status board being displayed in a portion of said screen separate from, but simultaneously with, said display of said workbench icons.

13. A system for managing according to claim 12 wherein said screen displays visual representations of each of plurality of work areas, said system including software means responsive to inputs of production progress in each of said work areas for updating the corresponding visual representations at said screen.

14. A system for managing according to claim 13 wherein said screen display has upper and lower portions identified by contrasting colors, said upper portions containing a plurality of “radio” buttons associated with corresponding ones of said workbench icons, said lower portions providing a summary of the status of said principal work areas.

15. A system for managing according to claim 14 wherein said lower portions include visual representation showing the completion status of work.

16. A system for managing according to claim 15 wherein said software means includes means for displaying in said lower portion of said display the projected future work load for each of said resources.

17. A system for managing according to claim 16 wherein said lower portion includes a further plurality radio buttons operable to bring up a respective further display, each said further display having upper and lower portions, said upper portions containing an array of icon-accompanied buttons addressable to provide more detailed control of an addressed operation and said lower portions providing more detailed status information relating to said addressed operation.

18. A system for managing according to claim 17 wherein each said further display repeats in a corner thereof the icon accompanying the originally addressed button as a trail-marker.

19. A computer-controlled printing facility having a plurality of on-premises resources including printers and design stations for processing jobs, comprising:
a console display having a plurality of icons representing each of said plurality of said resources;
a profile register for storing the detailed attributes of each of said resources;
means for receiving jobs to be processed by said resources according to a schedule;
a queue for storing said jobs until said resources are ready to process said jobs; and
means responsive to said jobs receiving means for consulting said profile register to assign said jobs to appropriate ones of said queues.

20. A computer-controlled printing facility according to claim 19 wherein said console includes a status board for showing whether said jobs are proceeding on said schedule, said status board being displayed in a portion of said screen separated from, but simultaneously with, said display of said workbench icons.

21. A computer-controlled printing facility according to claim 20 wherein said console includes means for displaying the availability of said resources to process said jobs.

22. A computer-controlled printing facility according to claim 21 wherein said console includes means for overriding said displayed availability of said on-premises resources and for assigning said job to an off-premises resource.

23. A computer-controlled printing facility according to claim 21 wherein said profile register stores attributes of off-premises printing resources.

24. A computer-controlled printing facility according to claim 23 wherein said console includes means for assigning said job to one of said off-premises printing resources.

25. In a multistage process where work items are moved through a sequence of production areas, the improvement comprising:
a computer control system including software means for displaying on a monitor associated with said computer a visual presentation of the real time progress of said work items in said areas, said system being programmed to:
check the status of each of said production areas periodically,
determine the instantaneous progress of each of said work items in said production areas, and
move a visual representation of one of said work items a distance corresponding to said instantaneous progress.

26. In a multistage process according to claim 25 the improvement wherein said system is programmed to set said visual representation of one of said work items back to a preset starting point when said status check indicates a lack of sufficient instantaneous production capacity at a corresponding one of said production areas.

27. In a multistage process according to claim 25 the improvement wherein said system is programmed to display a stylized tractor the position of which along a horizontal axis is determined by the instantaneous assessment of progress of one of said work items.

28. In a multistage process according to claim 27 the improvement wherein said system is programmed to display a second visual representation positioned visually close to said first visual representations, said second visual representation displaying an assessment of the instantaneous production capacity of said production areas.

29. A multistage process where work items are moved through a sequence of production queues, the improvement comprising:
a computer control system including software means for displaying on a monitor associated with said computer a visual presentation of the real time progress of said work items in said queues, said system having:
a profile register for storing the detailed attributes of resources at each of said production queues;
means for receiving jobs to be processed by said resources according to a schedule; and
means responsive to said jobs receiving means for consulting said profile register to assign said jobs to appropriate ones of said production queues.

30. A multistage process according to claim 29 wherein said attributes are selected from the group consisting of the number and capabilities of print shop personnel; the number and types of presses; the number and capabilities of analog and digital printers; the inventory of materials and supplies; the number and capabilities of vendors and sources of supply; the number and capabilities of resources available at a print shop having idle resources.

31. A multistage process according to claim 30 wherein said attributes pertaining to print shop personnel are selected from the group consisting of payroll account numbers and job descriptors.
